(19) United States
(12) Patent Application Publication
(10) Pub. No.: US 2016/0033660 A1
(43) Pub. Date: Feb. 4, 2016

(54) INTERNAL BEND RESTRICTOR FOR OPTO/ELECTRICAL ARMORED CABLES

(71) Applicant: ION GEOPHYSICAL CORPORATION, Houston, TX (US)

(72) Inventors: André W. OLIVIER, River Ridge, LA (US); Kyle J. SEDLACEK, New Orleans, LA (US)

(73) Assignee: ION Geophysical Corporation, Houston, TX (US)

(21) Appl. No.: 14/774,544

(22) PCT Filed: Mar. 11, 2014
(86) PCT No.: PCT/US2014/023523

§ 371 Date: Sep. 10, 2015

Related U.S. Application Data
(60) Provisional application No. 61/780,530, filed on Mar. 13, 2013.

(51) Int. Cl. G01V 1/20; G01V 1/38

(52) U.S. Cl. CPC G01V 1/201; G01V 1/3852

(57) ABSTRACT

Embodiments of the invention provide methods, systems, and apparatus for collecting seismic data in a marine environment. An ocean bottom cable (OBC) comprising a plurality of sensor nodes for collecting seismic data may be deployed to and retrieved from an ocean bottom during seismic operations using a winch. Such deployment and retrieval operations may exert substantial stress on the OBC at an interface between the sensor nodes and cable segments of the OBC. A reinforcement sleeve is provided to reduce the mechanical stress at such interfaces.

### CROSS REFERENCE TO RELATED APPLICATIONS

This application claims priority to and the benefit of PCT Application No. PCT/US2014/023523, entitled “Internal Bend Restrictor for Opto/Electrical Armored Cables,” which was filed on Mar. 11, 2014, and claims priority to and the benefit of U.S. provisional application No. 61/780,530, entitled “Internal Bend Restrictor for Opto/Electrical Armored Cables,” which was filed on Mar. 13, 2013, each of which is hereby incorporated by reference in its entirety for all purposes.

### BACKGROUND

1. Field

The present invention generally relates to seismic data acquisition, and more specifically to ocean bottom seismic data acquisition systems.

2. Description of the Related Art

In conventional marine seismic surveying, a vessel tows a seismic source, such as an air gun array, that periodically emits acoustic energy into the water to penetrate the seabed. Sensors, such as hydrophones, geophones, and accelerometers may be housed in sensor units at sensor nodes periodically spaced along the length of an ocean bottom cable (OBC) resting on the seabed. The sensors of the sensor node are configured to sense acoustic energy reflected off boundaries between layers in geologic formations. Hydrophones detect acoustic pressure variations; geophones and accelerometers, which are both motion sensors, sense particle motion caused by the reflected seismic energy. Signals from these kinds of sensors are used to map the geologic formations.

Ocean bottom cables are typically deployed by unspooling them from a winch drum or winch reel located on a vessel, e.g., a cable handling vessel. After the seismic operations are completed at a given location, the ocean bottom cables may be reeled back on to the winch reel or drum and moved to a different location. Such deployment, retrieval, and redeployment may take place several times during a seismic survey.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an example of a seismic survey according to an embodiment of the invention.

FIG. 2 illustrates an exemplary sensor node according to an embodiment of the invention.

FIG. 3 illustrates a sensor node placed on a winch according to an embodiment of the invention.

FIG. 4 illustrates an exemplary reinforcement sleeve according to an embodiment of the invention.

FIG. 5 illustrates another exemplary reinforcement sleeve according to an embodiment of the invention.

### DETAILED DESCRIPTION

Embodiments of the invention provide methods, systems, and apparatus for collecting seismic data in a marine environment. An ocean bottom cable (OBC) comprising a plurality of sensor nodes for collecting seismic data may be deployed to and retrieved from an ocean bottom during seismic operations using a winch. Such deployment and retrieval operations may exert substantial stress on the OBC at an interface between the sensor nodes and cable segments of the OBC. A reinforcement sleeve is provided to reduce the mechanical stress at such interfaces.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

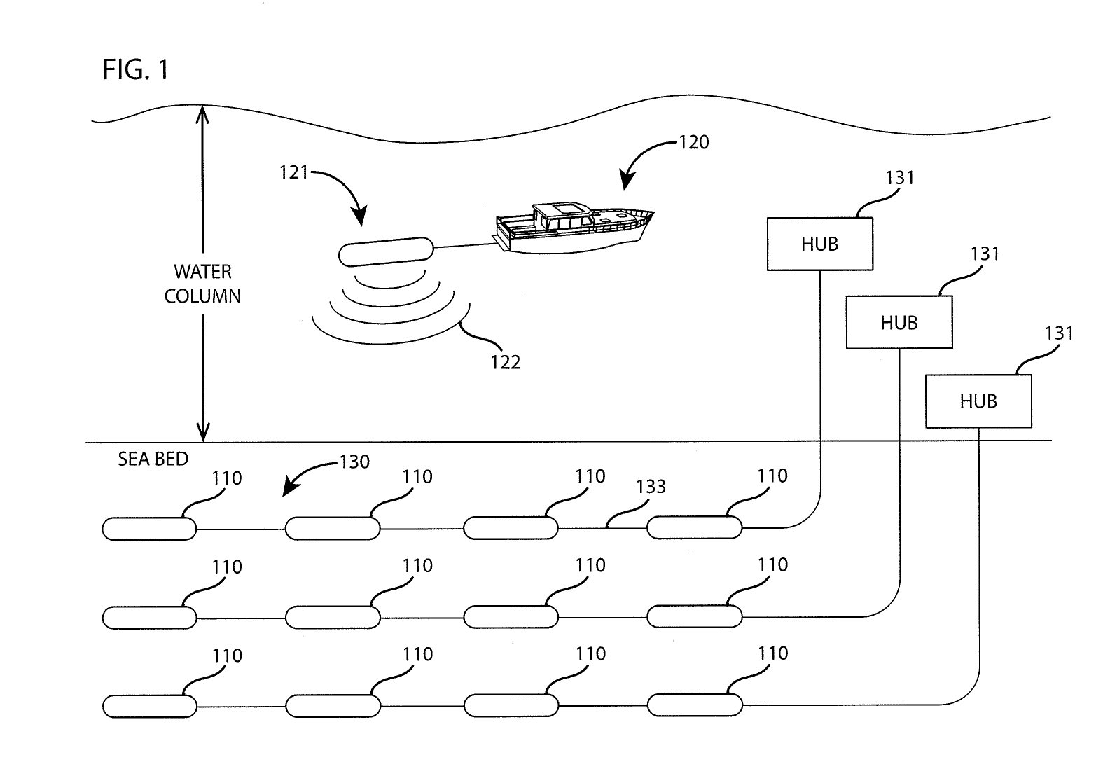

FIG. 1 illustrates an exemplary seismic survey according to an embodiment of the invention. As illustrated in FIG. 1, a source boat 120 may be configured to tow at least one seismic source 121 while conducting a seismic survey. In one embodiment, the seismic source 121 may be an air gun configured to release a blast of compressed air into the water column towards the seabed 111. As shown in FIG. 1, the blast of compressed air generates seismic waves 122 which may travel down towards the seabed 111, and penetrate and/or reflect from sub-seabed surfaces. The reflections from the sub-surfaces may be recorded by sensor nodes 110 as seismic data, which may be thereafter processed to develop an image of the sub-surface layers. These images may be analyzed by geologists to identify areas likely to include hydrocarbons or other substances of interest.

While reference is made to a sea floor and seabed herein, embodiments of the invention are not limited to use in a sea environment. Rather, embodiments of the invention may be used in any marine environment including oceans, lakes, rivers, etc. Accordingly, the use of the term sea, seabed, sea floor, and the like, hereinafter should be broadly understood to include all bodies of water.

As illustrated in FIG. 1, a plurality of sensor nodes 110 may be placed along each of one or more ocean bottom cable assemblies (OBCs) 130. The OBCs may be coupled to a respective hub device 131 (referred to hereinafter simply as the “hub”), as illustrated in FIG. 1. In one embodiment, the hubs 131 may be configured to float on the surface of the water column, as shown in FIG. 1. In alternative embodiments, the hub device may be placed on the sea floor 111, or may be configured to float in the water column at predefined depths. In general, the hubs 131 may include systems that support and facilitate collection of seismic data by the sensor nodes 110. For example, the hubs 131 may include seismic data storage systems configured to store seismic data collected by the sensor nodes 110, a power system to provide power to the hub and the nodes, high precision clocks to provide a clock signal, and the like.

As illustrated further in FIG. 1, a link system 133 (hereinafter referred to simply as “link”) may transfer power, data, instructions, and the like from the hub 131 to the sensor nodes 110. As illustrated in FIG. 1, the link 133 may include a plurality of cable segments coupling the sensor nodes 110 and the hub 131. In one embodiment, the link 133 may include a plurality of transmission lines. For example, a first plurality of transmission lines may be configured to transfer data between the sensor nodes and the hub, a second plurality of data lines may be configured to transfer instructions between the sensor nodes and the hub, and a third one or more transmission lines may transfer power from the hub to the sensor nodes. In alternative embodiments, the same set of transmission line or lines may be used to transfer one or more of seismic data, instructions, and/or power. Moreover, while a single link 133 is referred to herein, in alternative embodiments, a plurality of links may be included to transfer the seismic data, instructions, and power between the sensor nodes 110 and respective hubs 131.

In one embodiment of the invention, the sensor nodes 110 may be coupled to each other serially. Therefore, each node may be configured to receive and transfer instructions, data, power, etc. from a first node to a second node. In an alternative embodiment, the sensor nodes 110 may be connected in parallel via the link 133. In other words, one or more of the plurality of sensor nodes 110 may be directly coupled to the surface buoy 131 via the link 133. In other embodiments, the sensor nodes may be connected in any combination of serial and parallel connections with respect to each other, and direct and indirect coupling with the surface buoy.

In one embodiment of the invention, the cable segments forming the link 133 may be constructed of an outer jacket covering an inner core filled with material to keep water out. The outer jacket is preferably made of polyurethane and the core material is preferably polyethylene. Electrical cable bundles for powering, controlling, and reading the sensors and related electronics may run through the cable and terminate in connectors at ends of the sensor nodes 110. (The electrical cabling could alternatively be configured as a single bundle or multiple bundles). In one embodiment of the invention, the electrical cable bundles may be made from copper or a copper alloy.

In one embodiment, running through each cable of the link may be one or more stress members, which carry the tension in the cable. The stress members are preferably high modulus fiber ropes for strength, light weight, and flexibility with minimal stretch. They are preferably made of synthetic materials such as KEVLAR®, VECTRAN®, and DYNEEMA®. The synthetic ropes are easier to handle, allow for longer cables, and provide better acoustic isolation from the cable than more conventional wire ropes, which could also be used in applications not demanding high noise isolation.

In an alternative embodiment, the electrical bundles may be enclosed in a metal based stress member. Electrical isolation may be provided between the electrical bundles and the metal stress member such that the electrical bundles and the metal stress members form a substantially coaxial cable. In one embodiment of the invention, the metal stress member may be formed with galvanized steel.

While the link 133 is shown described herein as a link for transferring signals such as data, power, instructions, and the like, in alternative embodiments, the link 133 may simply be a physical link that does not carry any electrical signals. In such embodiments, communications between the sensor nodes and the hub devices may be performed using acoustic signals, electromagnetic signals, and the like. Furthermore, while each cable 130 is shown to be coupled with its own respective hub 131 in FIG. 1, in alternative embodiments, multiple cables 130 may be coupled to a single hub 131.

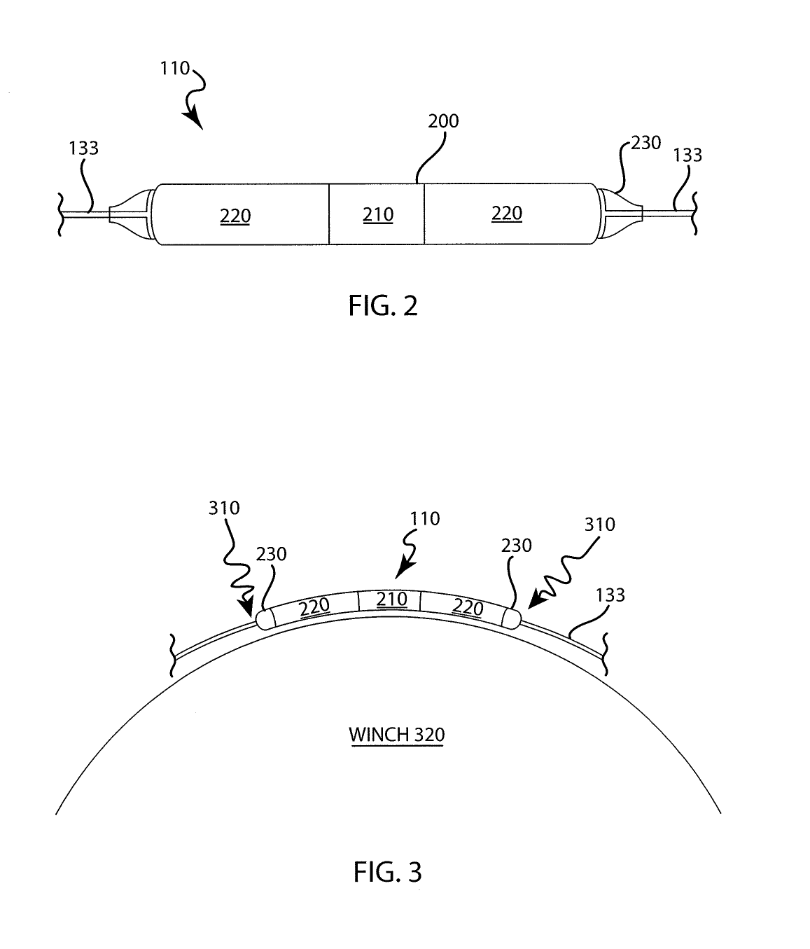

FIG. 2 illustrates a more detailed view of the sensor node 110 according to an embodiment of the invention. As illustrated, the sensor node 110 may include a body 200. The body may include a sensor module 210 and one or more vibration isolation devices 220. The sensor module may be configured to house one or more seismic sensors. Exemplary seismic sensors may include hydrophones, accelerometers, geophones, and the like. In one embodiment, the sensor module may be electrically and/or mechanically coupled with the cable 130, which may include a link 133 for transferring seismic data, instructions, power, and other signals.

The vibration isolation devices 220 may be configured to suppress noise that travels along the length of the cable 130, thereby adversely affecting the seismic data recordings of sensor module 210. In particular, the vibration isolation devices may be constructed in such a manner that the noise that travels along the length of the cable 130 is substantially absorbed, and thereby not transferred to the sensor module 210. Yet another advantage of the vibration isolation devices 220 is that they may prevent the heavy mechanical loads that may be placed on the sensor body 200 due to the tension in the cable 130/133 (see FIG. 1) during deployment and retrieval operations from damaging components sensor node 110. In one embodiment of the invention, the vibration isolation devices may be configured to flex sufficiently to relieve mechanical load on the sensor node 110, while a respective OBC is placed on a winch reel or drum. Vibration isolation devices 220 are described in greater detail in co-pending U.S. patent application Ser. No. 13/707,847, titled ROPE TENSION SYSTEM FOR A MARINE SEISMIC CABLE, filed on Dec. 7, 2012, which is hereby incorporated by reference in its entirety for all purposes.

FIG. 2 also illustrates termination cones 230 placed at an end of each of the vibration isolation devices 220. The termination cones 230 may be configured to mechanically couple a cable segment of the link 133 to the sensor node 110. In one embodiment of the invention, the termination cones 230 may be made from any suitable material, for example, metals and metal alloys. In a particular embodiment, the termination cones 230 may be made of stainless steel.

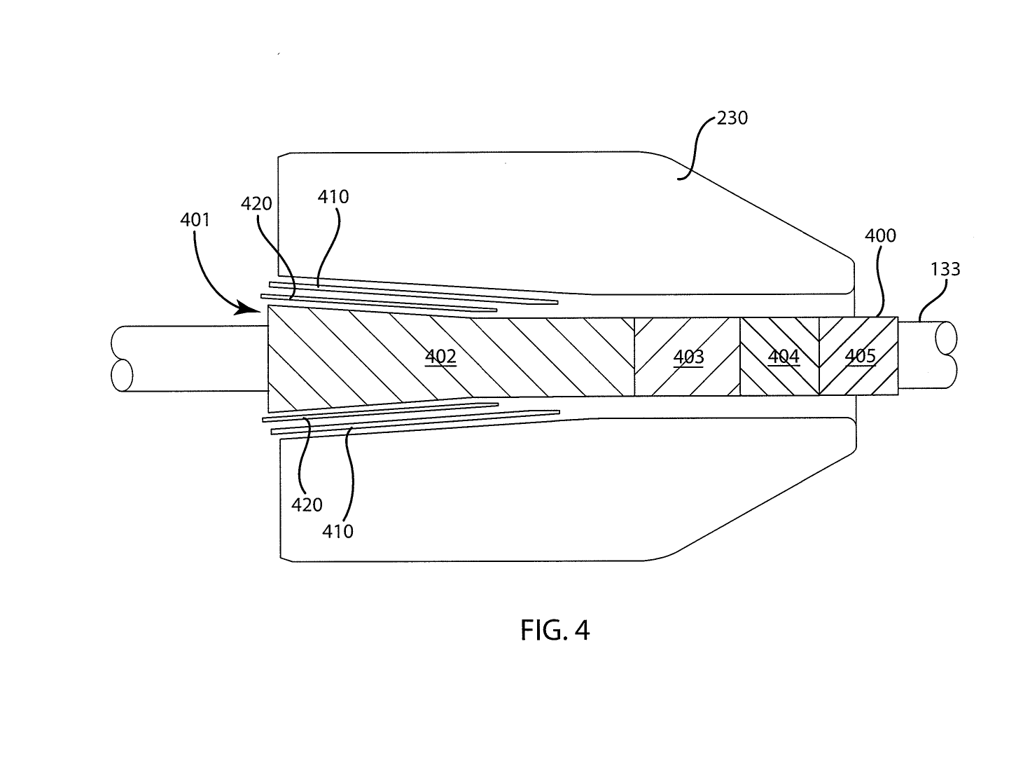

FIG. 3 illustrates a sensor node 110 on a winch 320. During deployment and retrieval of an ocean bottom cable comprising the sensor node 110, substantial tension and stress may be exerted on the ocean bottom cable. The mechanical stress placed on the OBC generally causes the OBC to conform to the curvature of the winch device. As illustrated in FIG. 3, the sensor node 110 may have a substantially elongated and straight body. While the vibration isolation devices 220 may provide some flexure and bending, it may not be sufficient to modify the shape of the sensor node 110 to conform to the curvature of the winch. As a result, substantial mechanical stress may be placed at locations 310 on the cable segments 133 in the termination cones 230. Such mechanical stress may damage electrical cables coupling of the sensor node 110 to other sensor nodes and/or the hub device 131.

Embodiments of the invention provide a reinforcement sleeve device that may help alleviate some of the mechanical stress and strengthen the connection of the cable segments 133 to the sensor nodes 110 at the termination cones 230. Furthermore, the reinforcement sleeve performs as a bend restrictor configured to prevent crush loads that may damage internal core members such as electrical and optical wiring within the cable segments when the cable segments are bent beyond acceptable limits.

FIG. 4 illustrates an exemplary reinforcement sleeve 400 (referred to hereinafter simply as the “sleeve”) according to an embodiment of the invention. As illustrated in FIG. 4, the sleeve 400 is configured to wrap around a cable segment 133 of the ocean bottom cable. The sleeve 400 is placed substantially within the termination cone 230 along a portion of the cable segment 133 that corresponds to the stress locations 310 shown in FIG. 3.

In one embodiment of the invention the sleeve may be made with high strength corrosion resistant stainless steel. However, in alternative embodiments, the sleeve may be a made from any suitable material capable of satisfying a predefined set of bending stress requirements. Exemplary materials that may be used to form the sleeve may include metals, metal alloys, KEVLAR, fiber reinforced materials, and the like. As illustrated in FIG. 4, the sleeve may include a flared end 401.

In one embodiment of the invention, one or more cones may wrap around the sleeve 400. For example, a first cone 410 and a second cone 420 are shown in FIG. 4. The outer cones 410 and 420 may be configured to provide further reinforcement for cable segment 133. In one embodiment, the outer cones 410 and 420 may be configured to grip the termination cone 230. The outer cones 410 and 420 may be made from stainless steel. However, in alternative embodiments any suitable material, e.g., metal or metal alloys may be used.

In one embodiment of the invention, the sleeve 400 may be formed out of a plurality of cylindrical or substantially cylindrical sections coupled together. For example, sections 402, 403, 404, and 405 are shown in FIG. 4. The sleeve 400 may be formed with any number of sections, of any shape. Furthermore, different sections may be composed of different materials of varying strength. In some embodiments, the sleeve may include kerf cuts at predefined locations to allow some bending, while at the same time restricting crush loads. In an alternative embodiment, the sleeve 400 may be a monolithic piece formed with uniform or varying material properties.

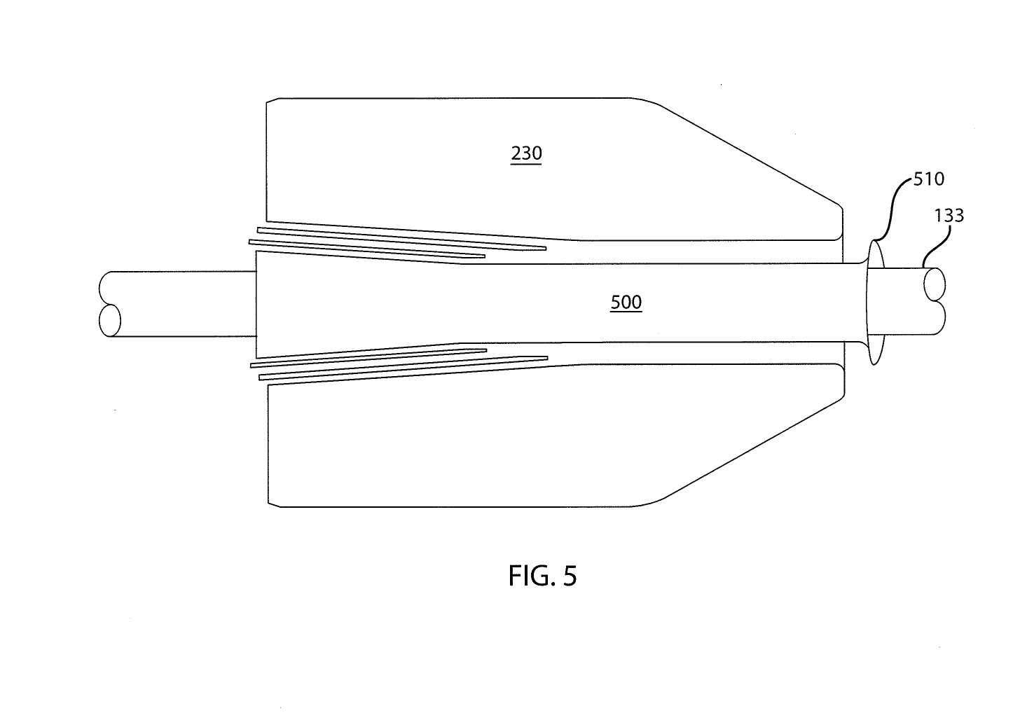

FIG. 5 illustrates another embodiment of a reinforcement sleeve, according to an embodiment of the invention. As illustrated, the sleeve 500 may be substantially similar to the sleeve 400 of FIG. 4. However, the sleeve 500 is shown with a flared opening 510. The flared opening 510 may be configured to further alleviate mechanical stress on the cable segment 133 while the cable is placed under high tension on a winch device, by allowing the cable to better conform to the curvature of the winch.

While the bend restrictor/reinforcement sleeve is described with reference to ocean bottom seismic data acquisition systems herein, embodiments of the invention are not limited only to seismic data acquisition. The reinforcement sleeve may be used with any type of cable or cable segments having end terminations that are vulnerable to mechanical failure if thresholds for bending radii are exceeded. For example, under sea communications cables may include a plurality of interconnected cable segments having electrical or optical cores. The points of interconnection may be vulnerable to mechanical failure during deployment and retrieval operations. Such interconnection points may be secured by strategically placing reinforcement sleeves thereon to improve bend-tolerance.

Embodiments of the invention are also not limited to cables transferring electrical or optical data. In alternative embodiments, the reinforcement sleeve may be used in conjunction with any type of cable, for example, irrigation cables/hoses, power lines, etc. In general, the reinforcement sleeve may be used with any type of cable likely to be subjected to bending and having identifiable failure points.

Furthermore, while the sleeve is shown as having a substantially straight line cylindrical axis, in alternative embodiments, the cylindrical sleeve may include a bend. Whether the sleeve is formed as a straight or bended cylinder, the sleeve generally forms a bend restrictor that prevents cables from exceeding bending thresholds, and therefore being damaged.

While the foregoing is directed to embodiments of the present invention, other and further embodiments of the invention may be devised without departing from the basic scope thereof, and the scope thereof is determined by the claims that follow.

1. A sensor node comprising:
a sensor module comprising one or mode seismic sensors;
a termination unit configured to couple the sensor node to an ocean bottom cable segment; and
a reinforcement sleeve placed substantially within the termination unit, wherein the reinforcement sleeve is configured to alleviate mechanical stress placed on the ocean bottom cable segment.

2. The sensor node of claim 1, wherein the reinforcement sleeve comprises a first flared end proximate to the sensor module.

3. The sensor node of claim 1, wherein the reinforcement sleeve comprises a second flared end proximate to an opening in the termination unit.

4. The sensor node of claim 1, wherein the reinforcement sleeve is made from high strength corrosion resistant stainless steel.

5. The sensor node of claim 1, wherein the reinforcement sleeve is composed of a plurality of substantially cylindrical sections coupled to each other.

6. An ocean bottom seismic data acquisition cable, comprising:
a plurality of sensor nodes, each sensor node comprising:
a sensor module comprising one or mode seismic sensors;
a termination unit configured to couple the sensor node to an ocean bottom cable segment; and
a reinforcement sleeve placed substantially within the termination unit, wherein the reinforcement sleeve is configured to alleviate mechanical stress placed on the ocean bottom cable segment; and
a plurality of cable segments, each cable segment being configured to couple a first one of the plurality of sensor nodes to a second one of the plurality of sensor nodes.

7. The ocean bottom seismic data acquisition cable of claim 6, wherein the reinforcement sleeve comprises a first flared end proximate to the sensor module.

8. The ocean bottom seismic data acquisition cable of claim 6, wherein the reinforcement sleeve comprises a second flared end proximate to an opening in the termination unit.

9. The ocean bottom seismic data acquisition cable of claim 6, wherein the reinforcement sleeve is made from high strength corrosion resistant stainless steel.

10. The ocean bottom seismic data acquisition cable of claim 6, wherein the reinforcement sleeve is composed of a plurality of substantially cylindrical sections coupled to each other.

11. The ocean bottom seismic data acquisition cable of claim 6, further comprising a hub device coupled to at least one of the plurality of sensor nodes.

12. A cable system, comprising
at least one cable segment, the cable segment comprising at least one termination point; and
a reinforcement sleeve placed at or near the termination point of the cable segment.

13. The cable system of claim 12, wherein the reinforcement sleeve comprises a flared end.

14. The cable system of claim 12, wherein the reinforcement sleeve is made from high strength corrosion resistant stainless steel.

15. The cable system of claim 12, wherein the reinforcement sleeve is formed as a bended cylinder.
